(19) United States
(12) Patent Application Publication
(10) Pub. No.: US 2025/0293798 A1
(43) Pub. Date: Sep. 18, 2025

(54) EFFICIENT APPLICATION OF ADAPTIVE CODING AND MODULATION IN COMMUNICATION SYSTEMS

(71) Applicants: AT&T Intellectual Property I, L.P., Atlanta, GA (US); AT&T Mobility II LLC, Atlanta, GA (US)

(72) Inventors: Farhad Barzegar, Branchburg, NJ (US); Mark N. Evans, Ewing, NJ (US); Larry Gurule, Durango, CO (US)

(73) Assignees: AT&T Intellectual Property I, L.P., Atlanta, GA (US); AT&T Mobility II LLC, Atlanta, GA (US)

(21) Appl. No.: 18/603,948

(22) Filed: Mar. 13, 2024

(51) Int. Cl. H04L 1/00; H04B 17/345; H04L 1/20

(52) U.S. Cl. CPC H04L 1/0013; H04B 17/345; H04L 1/0003; H04L 1/203

(57) ABSTRACT

Aspects of the subject disclosure may include, for example, obtaining a received signal including information transmitted over a physical channel of a communications link, measuring a quality of the communications link according to the received signal, and characterizing interference according to the measured quality. An adaptive coding and modulation (ACM) algorithm is selected from among a group of different ACM algorithms based on the characterized interference. The selected ACM algorithm is adapted to increase information throughput of the communications link over alternative ACM algorithms of the group of different ACM algorithms in view of the characterized interference. Other embodiments are disclosed.

### FIELD OF THE DISCLOSURE

The subject disclosure relates to an efficient application of adaptive coding and modulation in communication systems.

### BACKGROUND

In traditional point-to-point microwave systems, during regular operation, adaptive coding and modulation (ACM) may be applied to improve the overall availability of the system. In digital communication systems, modulation relates to a mapping of information bits to symbols that may be exchanged with a remote terminal over a communications channel. Generally, higher complexity modulation schemes map more bits per symbol increasing an information throughput of the communications channel. Physical realities of the communications channel include noise and/or interference, which may introduce errors, thus providing some limit on modulation complexity.

Communication systems commonly include some form of encoding to facilitate detection and in at least some instances correction of errors introduced by the physical channel. Such encoding schemes generally add redundant information, i.e., bits that are transported over the channel with the information and usable at a receiving end to detect and/or correct errors. The greater the amount of redundant information, the lesser the amount of information that may be supported by the physical communications channel.

The modulation complexity and encoding may be applied in an adaptive manner, such that one or more of the modulation complexity and/or encoding may be adjusted through an ACM process. The ACM process may monitor communications and respond to conditions encountered over a physical communications channel to promote an efficient use of communications resources.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network configured with adaptive coding and modulation (ACM) in accordance with various aspects described herein.

FIG. 2A is a block diagram illustrating an example, non-limiting embodiment of a communications system employing ACM and functioning within the communications network of FIG. 1 in accordance with various aspects described herein.

FIG. 2B is a block diagram illustrating an example, non-limiting embodiment of another communications system employing ACM and functioning within the communications network of FIG. 1 in accordance with various aspects described herein.

FIG. 2C is a block diagram illustrating an example, non-limiting embodiment of yet another communications system employing ACM and functioning within the communications network of FIG. 1 in accordance with various aspects described herein.

FIG. 2D is a graph illustrating an example, non-limiting embodiment of an example ACM performance functioning within the communications network of FIG. 1 in accordance with various aspects described herein.

FIG. 2E depicts an illustrative embodiment of an ACM process in accordance with various aspects described herein.

FIG. 2F depicts an illustrative embodiment of another ACM process in accordance with various aspects described herein.

FIG. 3 is a block diagram illustrating an example, non-limiting embodiment of a virtualized communications network configured with ACM in accordance with various aspects described herein.

FIG. 4 is a block diagram of an example, non-limiting embodiment of a computing environment configured with ACM in accordance with various aspects described herein.

FIG. 5 is a block diagram of an example, non-limiting embodiment of a mobile network platform configured with adaptive coding and modulation in accordance with various aspects described herein.

FIG. 6 is a block diagram of an example, non-limiting embodiment of a communications device configured with adaptive coding and modulation in accordance with various aspects described herein.

### DETAILED DESCRIPTION

The subject disclosure describes, among other things, illustrative embodiments for obtaining a quality measure, detecting and characterizing interference in a communication system according to the quality measure and selecting an adaptive coding and modulation (ACM) algorithm responsive to the quality measure. Other embodiments are described in the subject disclosure.

One or more aspects of the subject disclosure include a process that includes receiving, by a processing system including a processor, a signal including information transmitted over a physical channel of a communications link, to obtain a received signal. A quality measure of the communications link is calculated, by the processing system, according to the received signal, interference is characterized, by the processing system, according to the quality measure of the communications link, to obtain characterized interference, and an ACM algorithm is selected, by the processing system, from among a plurality of different ACM algorithms based on the characterized interference, to obtain a selected ACM algorithm. The selected ACM algorithm is adapted to increase information throughput of the communications link over alternative ACM algorithms of the plurality of different ACM algorithms in view of the characterized interference.

One or more aspects of the subject disclosure include a system, including a processing system including a processor and a memory that stores executable instructions that, when executed by the processing system, facilitate performance of operations. The operations include obtaining a received signal including information transmitted over a physical channel of a communications link, measuring a quality of the communications link according to the received signal, to obtain a measured quality, and characterizing interference according to the measured quality, to obtain characterized interference. The operations further include selecting an ACM algorithm from among a number of different ACM algorithms based on the characterized interference, to obtain a selected ACM algorithm, wherein the selected ACM algorithm is adapted to increase information throughput of the communications link over alternative ACM algorithms of the number of different ACM algorithms in view of the characterized interference.

One or more aspects of the subject disclosure include a non-transitory, machine-readable medium, including executable instructions that, when executed by a processing system including a processor, facilitate performance of operations. The operations include obtaining a received signal comprising information transmitted over a physical channel of a communications link, determining a quality metric of the communications link according to the received signal, and identifying, according to the quality metric, a type of interference from among a number of different types of interference, to obtain an identified type of interference. An ACM algorithm is configured according to the identified type of interference, to obtain a configured ACM algorithm, wherein the configured ACM algorithm is adapted to optimize information throughput of the communications link.

After the initial connection, a communications system, such as a point-to-point microwave radio communications system operating in frequency division duplex (FDD) normally progresses to employ a highest modulation possible, e.g., configured to have a highest throughput available. A transmitter on one side gathers enough input information bytes to fill its internal buffer, and then modulates a radio frequency (RF) carrier according to the ACM. A receiver on the other end of the link receives the frame. During a demodulation process, the receiver applies signal processing to calculate an error vector magnitude (EVM) of the frame. The frame EVM is determined by calculating mean squared errors for every symbol of the frame. Ideally, the EVM should be 0, that is, all received symbols should be identical to every transmitted symbol. Of course, in real life, there are factors such as thermal noise, non-linearity of transmitter, peak-to-rms ratio limitations, etc., that will create non-zero EVM. The signal processing section can correct the symbols to their original shape in low EVM conditions and recover the frame. In higher EVMs, many other digital techniques such as coding, e.g., forward error correction (FEC) coding, apply redundant bits and/or interleaving to recover symbols of the frame.

As EVM increases, due to natural events such as fading caused by rain, the EVM may reach a level beyond which none of the above methods can recover the frame and it will be lost. This will be visible to the end user of the system. To overcome this situation, the receiver side calculates the EVM and signals the transmitter side, e.g., through a control channel and/or internal messages, indicating a worsening EVM. Based on this information, the transmit side may reduce its constellation and/or strengthen its FEC, in an effort to reduce the EVM to a more manageable level, generally resulting in a lower throughput. This ACM adjustment process may take several frames, settling at a level at which the RF channel may be properly characterized.

When the natural event has subsided, the EVM, e.g., calculated at the receiver side, will improve and will be reported back to the transmitter side. The transmitter can now modulate data with more complex constellations and/or reduced FEC levels allowing higher throughput. Many internal messages are exchanged to keep both sides of the link in sync. This process continues back and forth allowing maximum throughput for the available condition.

While the traditional ACM may respond satisfactorily to natural, relatively slow, changes to the EVM, the same has been found not true for other degrading factors, such as interference, and particularly in the form of short but intense interference, sometimes referred to as “bursty” interference. The point-to-point microwave links normally operate within licensed frequencies and are carefully vetted to prevent interferences from other point-to-point links that might cross their path or be at frequencies close enough to cause problems.

This was the case until 2020 when the FCC allowed operation of unlicensed equipment at the same frequencies of the licensed links, e.g., Wi-Fi 6E, though not expected to be the only unlicensed equipment to operate in these bands, is among the first equipment of this type. It was done based on a premise that the low-power-indoor (LPI) Wi-Fi equipment is too weak, and the point-to-point link beamwidths are too narrow to be interfered with. However, extensive field measurements were made that indicated surprisingly high levels of interference from unlicensed Wi-Fi 6E equipment into “operating” 6 GHz microwave links. Another point observed in the field, and later verified in lab measurements, is that point-to-point links that were configured for ACM, and normally operating at maximum constellations, were more susceptible to the Wi-Fi 6E interference than the links setup with fixed modulation at somewhat lower levels.

It is understood that the ACM-enabled links are programmed for natural causes such as fading or interference from other links which will happen in much longer periods and therefore give the system time to properly adjust. When Wi-Fi 6E, and later developments, e.g., Wi-Fi 7, devices interfere with point-to-point microwave links, the interference is observed to be relatively short and bursty in nature. When the receiver detects increased MSE, it is sudden and can wipe out an entire frame during which it was detected. At this point, the receiver may send internal messages to the other side's transmitter asking for lower constellation and/or more FEC depending on the MSE. Subsequent frames, e.g., the next frame, can be configured and transmitted at this new, lowered constellation that is received with a new calculated MSE. If the estimation was done correctly, the MSE will be low enough and the new frame is properly detected and passed on. The link will again try to improve throughput by estimating a higher constellation or lower FEC for the next frame. This constant going back and forth can at times become unstable causing frame errors and even link disconnects.

With this on-and-off, bursty interference, the estimation for the next constellation/Coding level (FEC) is much trickier than the reduced MSE due to fading, for example. The techniques disclosed herein address this situation. For example, when a sudden MSE degradation is detected, an ACM and/or MCS controller may immediately request a lower constellation and/or a higher FEC level, i.e., more redundant bits, than normal. The ACM and/or MCS controller may continue communicating at this constellation/code and monitor MSE for subtle degradation during the next several frames, e.g., for a pre-determined duration. This approach allows for interference, e.g., a Wi-Fi 6E (7) beacon or traffic (if any) to hit the frame. The amount of time spent on each constellation may be predetermined, e.g., being determined experimentally and/or through lab and field measurements.

If no further interference is detected, e.g., according to EVM values, the ACM and/or MCS may be applied to bring the constellation up, e.g., by one notch. In at least some embodiments, the process continued in a like manner until the maximum allowed constellation is reached. In at least some embodiments, a similar approach may be taken with the FEC. However, detection of MSE anomalies, e.g., increased error values and/or variations in error values during this operation may indicate presence of bursty interference, in which instances a migration of the constellation to higher level may be paused and/or terminated.

In at least some embodiments, it is envisioned that a new type of alarm may be issued indicating a detection and/or estimate of a particular type of interference, such as the example bursty interference. This alarm and others like it may be used to identify problem links over time, such that problematic links may be identified as candidates for future mitigation efforts such as moving to a different frequency band and/or using better (narrower) antennas. Alternatively, or in addition, indications of particularly sever interferers may be investigated, e.g., manually sought out and identified via field measurements, potentially resulting issuances of reports and/or warnings.

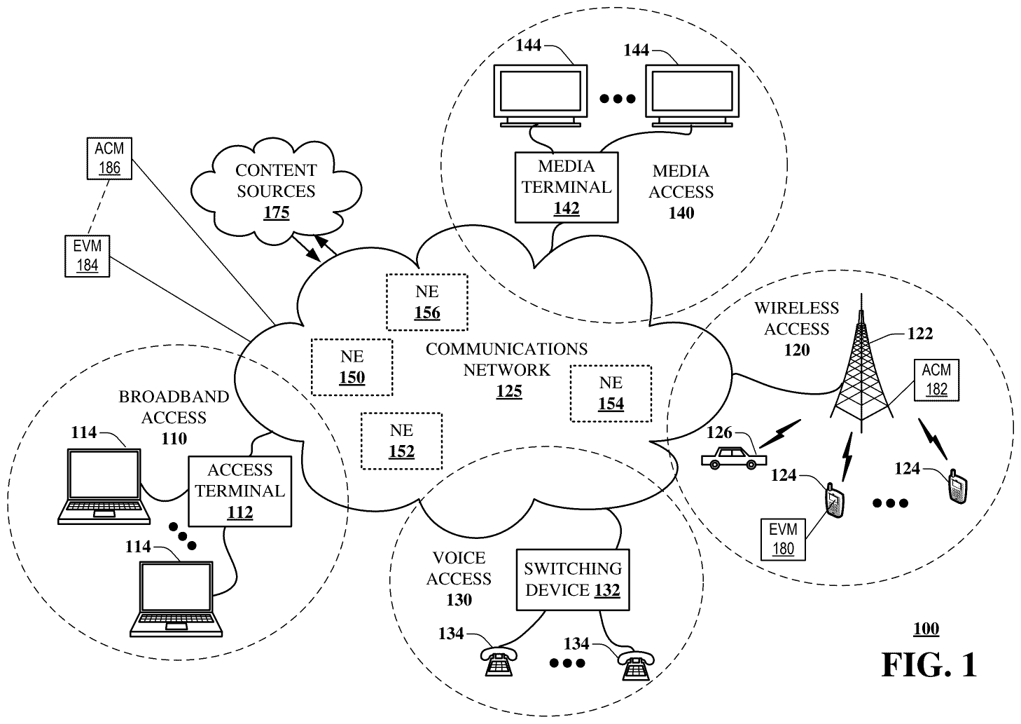

Referring now to FIG. 1, a block diagram is shown illustrating an example, non-limiting embodiment of a communications system 100 configured with adaptive coding and modulation (ACM) in accordance with various aspects described herein. For example, system 100 can facilitate in whole or in part, measuring a quality of a communications link according to a received signal, characterizing interference according to the measured quality, and selecting an ACM algorithm from among a group of different ACM algorithms based on the characterized interference. The selected ACM algorithm is adapted to increase information throughput of the communications link over alternative ACM algorithms of the group of different ACM algorithms in view of the characterized interference. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In at least some embodiments, the communications network 100 includes a link quality assessment module 180 configured to assess a quality of a communications link. By way of example, quality may be assessed according to EVM values that may be combined, e.g., according to a mean-squared-error (MSE) process, to obtain MSE values indicative of a link quality. Alternatively, or in addition, the communications network 100 may include an ACM controller 182, adapted to implement an ACM algorithm to control one of a modulation complexity and/or error correction rate in response to the MSE values. The ACM controller 182 may be configured to adjust the modulation and/or coding according to an algorithm adapted to return operation to pre-adjustment, e.g., maximum or optimal MCS values. Without limitation, the link quality assessment module 180 and/or the ACM controller 182 may be included within one or more of the mobile devices 124 and/or access points 122. Alternatively, or in addition, one or more of a link quality assessment module 184 and an ACM controller 186 may be provided separate from communications equipment, e.g., at a centralized location accessible via the communications network 125.

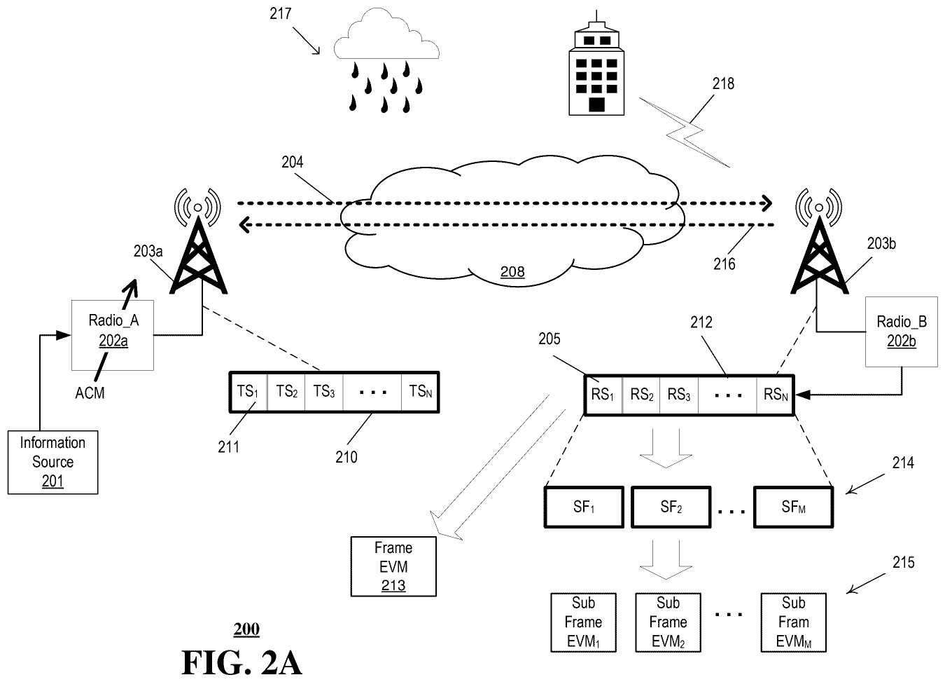

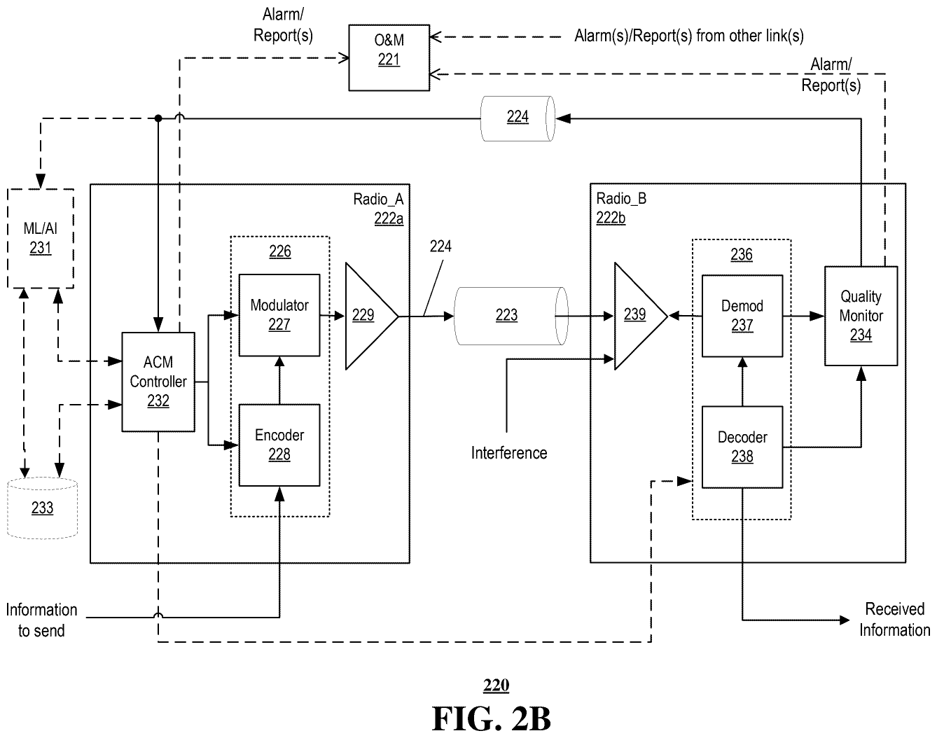

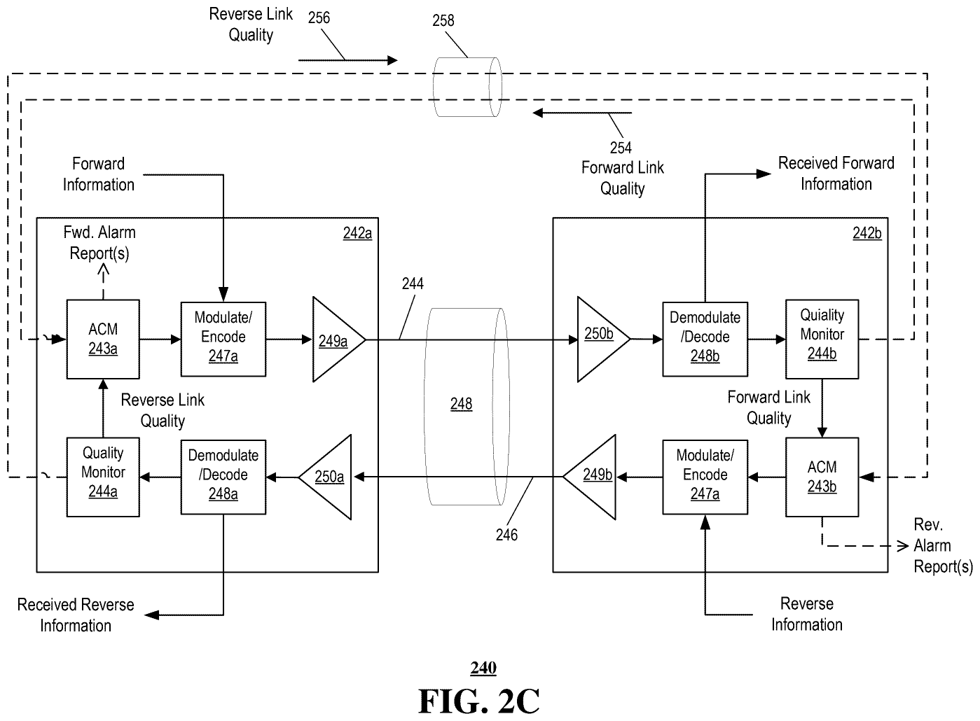

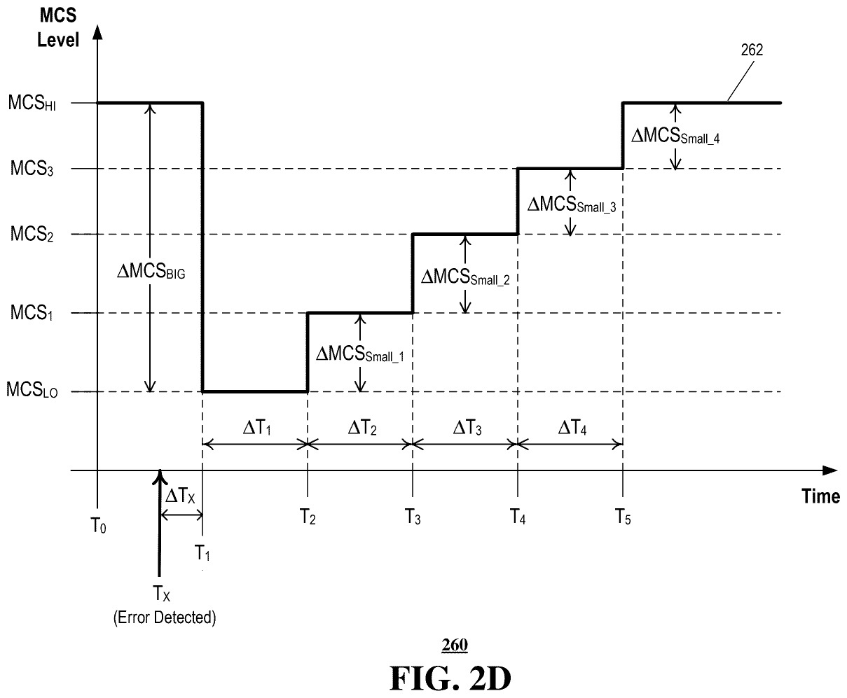

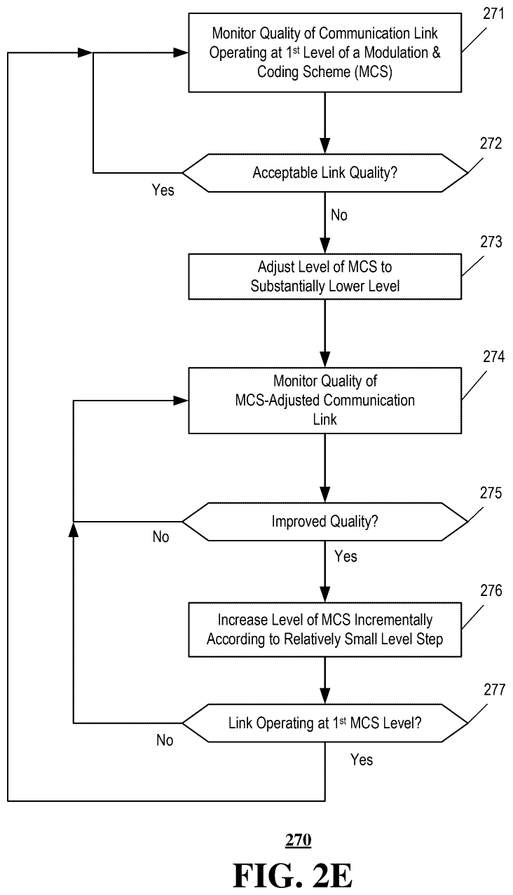

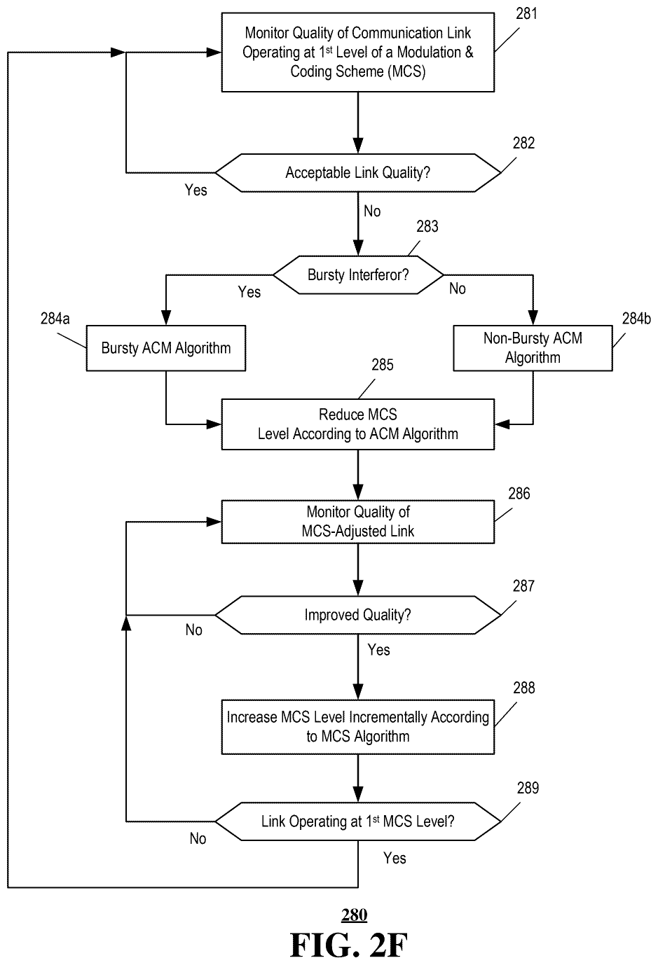

FIG. 2A is a block diagram illustrating an example, non-limiting embodiment of a communications system 200 employing adaptive coding and modulation (ACM) and functioning within the communications network 100 of FIG. 1 in accordance with various aspects described herein. The example communications system 200 includes a first radio system 202a electrically coupled to a first antenna 203a and a second radio system 202b electrically coupled to a second antenna 203b. The first radio system 202a obtains information from an information source 201 and processes the information as appropriate for transmission over a communications medium 208. According to the illustrative embodiment, the communications medium 208 is free space, and transmission of the information occurs over a first communications channel 204, such as a point-to-point, line of sight (LoS) radio link. Accordingly, the first radio system 202a prepares a radio signal that may be transmitted or launched via the first antenna 203a toward the second antenna 203b.

In at least some embodiments, the information is received in the form of and/or otherwise converted to digital data, which, in at least some embodiments, may be encoded in a manner to facilitate detection and/or correction of errors. Error coding may include, without limitation, block codes and/or convolutional codes that may include redundant data or parity bits in addition to the transmitted information. The encoded data may be mapped to symbols according to a modulation process and the symbols may be converted to analog signals that may be further processed by a radio frequency (RF) front end, e.g., frequency converted, filtered and/or amplified. It is common for the information, e.g., the symbols, to be organized according to a frame structure that includes an overhead or header portion and a data or payload portion. An example transmitter frame 210 includes a group of transmitter symbols 211 representing modulated, encoded data that may be transmitted toward the second radio system 202b via the first communications channel 204.

The second radio system 202b receives the transmitted information, e.g., a representation of the transmitter frame 210 as affected by a traversal of the communications medium 208 via the first communications channel 204. Accordingly, an RF signal conveying the transmitter frame 210 may be subjected to one or more channel conditions of path loss, noise, interference 218, multipath, fading, attenuation, absorption and/or scattering, e.g., as may result from atmospheric effects 217, such as atmospheric absorption and/or precipitation.

The second radio system 202b obtains a received signal via the second antenna 203b, which may include an RF signal conveying the transmitter frame 210. The second radio system 202b may include an RF front end configured to perform RF processing that may include one or more of amplification, frequency translation, e.g., down-conversion, and/or filtering. The second radio system 202b may include one or more of a detector, a demodulator and/or a decoder configured to further process the RF processed received signal.

In at least some embodiments, the second radio system 202b obtains a receiver frame 212 corresponding to a received version of the transmitter frame 210. The example receiver frame 212 includes a group of received symbols 205 corresponding to the group of transmitter symbols 211. It is understood that a quality of the receiver frame 212 and/or receiver symbols 205 may depend at least in part upon one or more of the channel conditions, e.g., including atmospheric effects 217 and/or interference 218. In at least some embodiments, the second radio system 202b includes a detector configured to compare symbols of the group of receiver symbols 205 to an expected symbol, e.g., an amplitude and/or phase state of a symbol constellation. An error may be determined according to a difference between the received symbol and the expected symbol, e.g., according to a difference vector.

In at least some embodiments, one of the first radio system 202a, the second radio system 202b or both is configured to determine a measure of a quality of the receiver frame 212. For example, the second radio system 202b may include an error module adapted to calculate a quality measurement according to difference vectors. In at least some embodiments, a frame error vector magnitude (EVM) 213 may be determined for the receiver frame 212 by calculating a mean-square error according to magnitudes of the error vectors for substantially all of the receiver symbols 205 of the receiver frame 212. A frame EVM 213 having a relatively low value may indicate a robust communications channel 204 capable of operating at a relatively high level of symbol encoding or modulation and/or a relatively low rate of error correction. Alternatively, frame EVM 213 having a relatively high value may indicate a compromised communications channel 204 incapable of operating at a relatively high level of symbol encoding or modulation and/or a relatively low rate of error correction. In such instances, it may be advantageous to adjust one or more of the modulation, e.g., to a lower-level modulation and/or a higher rate error correction encoding.

According to the illustrative example, the second radio system 202b may provide an indication of a quality of the receiver frame 212 to the first radio system 202a via a control channel 216. For example, an indication of a quality, such as the frame EVM 213 may be sent to the first radio system 202a via the control channel 216. The first radio system 202a, in turn, may adjust one or more of a modulation and/or an error encoding responsive to the quality measure. It is understood that such an adjustment to a modulation and coding scheme (MCS), e.g., to a lower level, may promote a reliable communication of information over the first communications channel 204 despite atmospheric effects 217 and/or interference 218. Albeit less information may be exchanged over the first communications channel 204, but preferably without a loss of a frame 212 and/or loss of a communications link over the first communications channel 204. In at least some embodiments, the first radio system 202a implements an ACM algorithm adapted to reconfigure an MCS of subsequent transmitter frames 210 in response to a quality value, such as the example frame EVM reported by the second radio system 202b via the control channel 216. It is envisioned that the ACM algorithm may be configured to reconfigure the MCS to a higher, and possibly a highest value should channel impairments improve.

In at least some embodiments, the EVM includes a mean-squared error (MSE) obtained for a group of symbols, e.g., for all symbols of a frame to obtain a frame EVM 213. Alternatively, or in addition, the EVM may be obtained according to an MSE for one or more groups of symbols within a frame. For example, a frame 212 may be divided into several sub-frames 214, such that subframe EVMs 215 may be obtained according to respective MSEs for each sub-frame. Large differences among these subframe EVMs 215, i.e., the subframe MSE values, may be understood as an indication of bursty interference. According to the techniques disclosed herein, operation at a maximum constellation should be reduced promptly, e.g., as soon as possible, to a value lower than maximum. A particular target lower value may be predetermined according to the MSE measurements. For example, greater MSE values may result in adjustment to lower target values, with a particular lower targe value depending on a level, difference, disparity and/or variability of these MSE measurements.

The lowered constellation may be referred to as a lowered or adjusted relative maximum constellation. It is understood that in at least some embodiments, a lowered maximum constellation may stay in effect until a predetermined time has passed without large fluctuations amongst frames and sub-frames' MSE measurements.

In at least some embodiments, application of a rapid reduction to the lowered maximum constellation may result in generation of an alarm, e.g., indicating the possibility of bursty interference. After an application of the constellation adjustment process returns operation to the original maximum constellation, the alarm may be cleared, allowing for the constellation to become more complex.

FIG. 2B is a block diagram illustrating an example, non-limiting embodiment of another communications system 220 employing ACM and functioning within the communications network 100 of FIG. 1 in accordance with various aspects described herein. The example communications system 220 includes a first radio system 222a and a second radio system 222b. The first radio system 222a is configured to obtain from an information source (not shown), information to be transmitted or sent to the second radio system 222b over a radio communications link. The first radio system 222a may process the information as appropriate for transmission via wireless communications over the radio link.

In at least some embodiments, the information may be received in a form of and/or otherwise converted to digital data, which, in at least some embodiments, may be encoded before transmission in a manner to facilitate detection and/or correction of errors upon reception. The first radio system 222a includes a modulation and encoding subsystem 226, which includes an encoder 228 and a modulator 227. The encoder 228 is configured to apply encoding, e.g., according to a channel coding process that encodes digital data, or information bits, according to a channel code, such as an error detection and/or correction code, to obtain encoded digital data or channel encoded data or bits. In at least some embodiments, the modulator 227 is configured to map the channel encoded data or bits to symbols according to a modulation process. The symbols, in turn, may be converted to analog signals that may be further processed by a radio frequency (RF) transmitter front end 229. The RF transmitter front end 229 may apply one or more of frequency conversion, filtering and/or amplification to obtain an RF signal. The RF signal may be launched, transmitted and/or otherwise exchanged with the second radio system 222b via a communications channel of a radio link, referred to herein as a payload channel 223. The payload channel 223 may include one or more allocated frequency bands or channels, e.g., licensed bands according to the example LoS communications system.

The second radio system 222b is configured to receive the transmitted information as may be affected by a traversal of a physical communications medium according to the radio link, via the payload channel 223. According to the illustrative example, the payload channel 223 and/or a receiver portion of the second radio system 222b may be subjected to interference. It is understood that the interference may have a time varying aspect, e.g., varying in amplitude, frequency, bandwidth, and/or severity over time. Such interference may be categorized and/or otherwise distinguished according to any combination of its corresponding physical traits. In at least some embodiments, the interference may be categorized and/or distinguished according to its corresponding time varying qualities. For example, some interference may occur for an extended duration as may be measured in seconds, minutes, or longer. Alternatively, some interference may occur for relatively short durations or bursts, e.g., occurring in time periods measured in relatively short time periods, such as milliseconds, or less. Any of the example interferences may vary in intensity and/or in duration of onset and/or dissipation, e.g., slowly rising and/or fading versus rapidly occurring at significant intensity, sometimes referred to as “bursty” interference. The example Wi-Fi interference related to authorized, unlicensed use and noted herein, may result in such bursty interference, versus weather related affects, which may occur over a longer durations and/or with less sudden onset and/or dissipations.

As discussed further herein, it is realized that different ACM configurations and/or algorithms may be better suited to different types and/or categories of interference. Accordingly, at least some embodiments disclosed herein, such as the example communications system 200 may include an ability to detect, distinguish and/or otherwise predict interference. More precisely, the example communications system 200 may be configured to further recognize a category and/or severity of interference, and to identify and/or apply an ACM configuration and/or algorithm to enhance and/or otherwise increase a wireless channel's capacity for reliable information exchange. In at least some embodiments a particular ACM configuration and/or algorithm is identified and/or applied to maximize and/or optimize such capacity in view of interference.

In more detail, the second radio 222b includes an RF receiver front end 239 and a demodulation and decoding subsystem 236 that includes a demodulator 237 and a decoder 238. The RF receiver front end 239 may be configured to perform RF processing that may include one or more of amplification, frequency translation, e.g., down-conversion, and/or filtering. The demodulator 237 is configured to obtain channel encoded data or bits from receives symbols according to a type and/or characteristic of a modulation applied by the modulator 227. Likewise, the decoder 238 is configured to decode the channel encoded data or bits to obtain information data or bits corresponding to the transmitted information. In at least some embodiments, the decoding may include error detection and/or correction.

It is understood that under ideal circumstances, the communications system 220 may be configured to reliably communicate a relatively high level of information at a relatively high information rate, e.g., maximizing an exchange of information between the first and second radio systems 222a, 222b. Such an optimal and/or preferred system configuration may include a relatively high-level of modulation, e.g., mapping a relatively large number of bits to each symbol. Alternatively, or in addition, such an optimal and/or preferred configuration may include an error code operating at a relatively low rate that together with the modulation level may support reliable communications of the relatively high, e.g., maximum, optimal and/or preferred rate of information exchange.

According to the illustrative embodiment, the second radio system 222b includes a quality monitor 234. The quality monitor 234 may be in communication with one or both of the demodulator 237 and the decoder 238. Accordingly, the quality monitor 234 may obtain a measure of overall quality of the communications link between the first and second radio systems 222a, 222b. A quality measurement may be based, at least in part, on input obtained from one or more of the demodulator 237 and the decoder 238. For example, the quality measurement may be based at least in part on an error vector magnitude (EVM) measurement as may be obtained according to a symbol detection process of the demodulator 237. It is understood that such EVM measurement may include some aggregate and/or combination of error vector measurements of individual symbols. For example, the EVM measurement may be obtained from a combination, e.g., an average of symbol EVM measurements over some group of symbols. In at least some embodiments, groups of symbols may be determined according to a data structure of received information, e.g., a frame structure, such that separate EVM measurements may be obtained for each frame according to an average, e.g., a root-mean-square (RMS) process. Alternatively, or in addition, groups of symbols may include multiple frames and/or sub-frames, such that EVM measurements may be obtained at a frame level, multi-frame level, and/or a sub-frame level. In at least some embodiments, multiple such EVM measurements may be obtained for the same received information, e.g., contemporaneously.

Further according to the illustrative example, the first radio system 222a includes an ACM controller 232. In at least some embodiments, the ACM controller 232 is configured to receive an indication of a quality of a communications link and, in response to the quality, to determine an appropriate modulation and/or encoding. The appropriateness of a modulation may include one or more of a type of modulation, a bit-to-symbol mapping ratio of the modulation, a data rate and any combination thereof. Likewise, the appropriateness of an encoding may include one or more of a type of encoding, e.g., a type of error detection and/or correction encoding, such as a type of forward error correction (FEC) encoding, a coding rate and combinations thereof. The ACM controller 232 may be configured to control and/or otherwise initiate a change in operation of the modulator 227, the encoder 228 or a combination thereof.

In at least some embodiments, a quality indicator, such as a quality measurement, e.g., EVM measurements, may be sent from the quality monitor 234 to the ACM controller 232 via a control channel 224. The control channel 224 may be provided together with the payload channel 223 in a common channel. The control channel 224 information may be separated from customer communications by one or more of time or frequency. Alternatively, or in addition, the quality measurements may be forwarded to the ACM controller 232 via a separate means, such as a dedicated O&M channel, e.g., a side link, a separate network connection, and the like.

In at least some embodiments, the ACM controller 232 may be configured to determine a modulation and/or coding scheme based on the quality measurements, e.g., based on the EVM measurements. In this regard, the ACM controller 232 may be configured and/or otherwise provide with a predetermined MCS scheme based on reported quality levels, e.g., EVM measurement values. In at least some embodiments, associations between different MCS schemes and reported EVM levels may be obtained via a function, e.g., a mapping function and/or by a lookup function. It is envisioned that at least some MCS schemes may identify modulation types and/or levels, error coding types and/or rates, and/or combinations thereof that should be utilized for a given EVM value. Such associations may be determined by calculation, estimation, empirical processes, or any combination thereof and provided as an appropriate function and/or lookup table.

In at least some embodiments, information supporting functionality of the ACM controller 232 may be retained in a storage system 233 (shown in phantom). The storage system 233 may include on-device storage, e.g., within the first radio 222a. Alternatively, or in addition, the storage system 233 may include off-device storage that may be locally accessible and/or remotely accessible by the first radio system 222a. It is envisioned that the storage system 233 may be configured to store MCS-to-EVM associations, e.g., according to indexed values. Alternatively, or in addition, the storage system 233 may be configured to store ACM algorithm supporting data, such as MCS mapping functions and/or MCS lookup tables.

It is worth noting here that the ACM functionality may reside at the first radio system 222a, e.g., at least partially within the ACM controller 232. Alternatively, or in addition, at least a portion of the ACM functionality may reside at the second radio system 222b, e.g., at least partially within the quality monitor 234. For example, the ACM controller 232 may implement an ACM algorithm directive, such as an MCS configuration based on an MCS-to-EVM association identified by ACM functionality at the second radio 222b. In at least some embodiments, at least a portion of the EVM monitoring and/or ACM functionality may be hosted on a separate system distinguishable from either of the first and second radio systems 222a, 222b. For example, a centralized quality monitoring service and/or ACM controlling service may be performed on another system, such as a dedicates system that may be configured to provide related functionality to multiple communications links and/or multiple radio communications systems supporting multiple communications links.

It is understood that, in at least some embodiments, the modulation and/or coding may be configured to ensure some minimum threshold level of service. The level of service may be measured according to one or more of data rate, type of service, a quality of service, and/or any combination thereof. Services may include, without limitation, streaming services, voice over IP (VOIP), machine type communications, e.g., Internet of things (IoT), enhanced 911, file transfer, and so on. In at least some instances, the threshold levels of service may be identified according to service level agreements (SLAs) between communication service suppliers and consumers.

In at least some embodiments, it is understood that the modulation and/or coding may be configured according to a business objective. By way of example, business objectives may include one or more of maximization of revenue, e.g., revenue obtained from communication services of one or more customers, minimization of communication degradations and/or outages, maximizing utilization of available communications resources, e.g., communications terminal equipment, transport media, e.g., waveguides, cabling, licensed and/or unlicensed frequency bands, bandwidths and/or channels. Alternatively, or in addition, business objectives may include minimization and/or optimization of other factors, such as power consumption, cooling capacity, operation and/or maintenance costs, spare capacity, redundancy, and so on.

Accordingly, it is understood that any of the novel techniques disclosed herein, such as quality monitoring and/or ACM algorithms may be adapted and/or otherwise configured in view of one or more business objectives. For example, an ACM controller 232 may be configured to implement one or more ACM algorithms adapted to respond to channel conditions and/or interference in a manner that addresses one or more such business objectives. As such business objectives may change from time to time, it is envisioned that the ACM controller 232 may be configured to respond to such changes. It is envisioned that such responsiveness may be automated, e.g., monitoring one or more business objectives and adapting an ACM algorithm in a responsive manner to achieve a new and/or changing business objective. To the extent that any changes to business objectives and/or channel conditions, e.g., interference, may be predictable, the ACM algorithms may be configured to respond to such changing objectives and/or conditions according to related predictions and/or schedules.

In at least some embodiments, functionality attributable to machine learning and/or artificial intelligence (ML/AI) may be utilized to facilitate an implementation of ACM within a communications link. According to the illustrative embodiment, the communications system 220 may include an ML/AI system 231 (shown in phantom). In at least some embodiments, when present, the ML/AI system 231 may be configured to support selection of an ACM algorithm from among a group of alternative ACM algorithms. The ML/AI system 231 may be preconfigured and/or otherwise suitably trained with a training data set. Subsequent training and/or improvement may be obtained in response to feedback to operations to effectively improve operation over time. In this regard, the ML/AI system 231 may be in communication with the storage system 233 to access training data, to store at least a portion of a trained neural network and/or to store other performance data as may benefit training and operation of the ML/AI system 231 to further business objectives utilizing the communications system 220.

For example, a first ACM algorithm may be adapted to respond to relatively slowly varying channel effects, such as precipitation and/or signal fading. Accordingly, the first ACM algorithm, when selected, may be utilized to adjust an MCS configuration in a manner adapted for the relatively slowly varying channel effects. This may include a relatively rapid adjustment from a normal or high MCS value to a substantially lower MCS value, followed, after some time, e.g., a single frame, or group of sequential frames, by a relatively rapid increase back to the normal or high MCS value. Alternatively, or in addition, in response to relatively slowly varying channel effects, the MCS may be reconfigured relatively slowly, e.g., sequentially reducing from a normal or high MCS value to a slightly lower MCS value. Further reductions may be implemented in a like manner until a satisfactory quality has been observed. Likewise, the MCS may be configured to return to the a higher MCS level, e.g., the normal or high MCS level relatively slowly, or rapidly, as may benefit an associated business objective. Reference to high and/or higher level MCS indicates those modulation and/or encoding configurations that enhance and/or otherwise improve an exchange of information between the first and second radio systems 222a, 222b. Improvements may include greater rates and/or quantities of information exchange.

Similarly, a second ACM algorithm may be adapted to respond to relatively fast varying channel effects, such as bursty interference as may be experienced in a presence of unlicensed Wi-Fi systems. The second ACM algorithm, when selected, may be utilized to adjust an MCS configuration in a manner adapted for the bursty channel effects. This may include a relatively rapid adjustment from a normal or high MCS value to a substantially lower, e.g., a minimum MCS value. The rapid reduction to MCS configuration level may be followed by, after some time, e.g., a single frame, or group of sequential frames, a relatively slow, e.g., sequentially increase from the minimum MCS value a normal or high MCS value to a slightly lower MCS value, according to multiple intervening MCS levels and/or time delays. Further reductions may be implemented in a like manner until a satisfactory quality has been observed.

In at least some embodiments, the communications system 220 is configured to generate an alarm in relation to the ACM capability. For example, an ACM controller 232 may be configured with a first MCS algorithm. The first MCS algorithm may be triggered responsive to quality reports received from the quality monitor 234. To the extent the first MCS algorithm is ineffective, the quality monitor 234 and/or the ACM controller 232 may generate an alarm indicator. For example, communications systems may be deployed with a first MCS algorithm adapted for typical, but not bursty interference. Activation of the first MCS algorithm, however, may not be effective in responding to bursty interference. Accordingly, error rates may remain high, possibly leading to lost frames and/or loss of a link. Upon a determination that application of the first MCS is ineffective, the ACM controller 232 and/or the quality monitor 234 may generate an alarm indicator.

The alarm indicator may be directed to an operation and maintenance (O&M) system 221. The O&M system 221 may determine from the alarm that the reporting communications link may be experiencing other issues, such as bursty interference. In response, the O&M system 221 may initiate a service request to update one or more of the ACM controller 232 and/or the quality monitor 234, e.g., adding a second ACM algorithm adapted to mitigate bursty interference. In at least some embodiments, the O&M system 221 may be configured to remotely provision, activate and/or update any such ACM algorithms, MCS-to-EVM mappings, and the like.

In at least some embodiments, the first radio system 222a, e.g., by way of the ACM controller 232, provides an indication to the second radio system 222b of a configured modulation and/or coding applied and/or about to be applied by the first radio system 222a. For example, the information may be provided in band, e.g., via the payload channel 223 and/or out-of-band, e.g., via the control channel 224. The modulation and/or coding configuration information may be utilized by the demodulation and decoding subsystem 236 to locally configure one or more of the demodulator 237 and/or the decoder 238 according to the modulation and/or encoding applied by the first radio system 222a.

FIG. 2C is a block diagram illustrating an example, non-limiting embodiment of yet another communications system 240 employing ACM and functioning within the communications network 100 of FIG. 1 in accordance with various aspects described herein. The example communications system 240 includes a first communications device 242a in communication with a second communications device 242b via a bidirectional communications channel 248. The bidirectional communications channel 248 supports a forward communications link 244 configured to communicate forward information, e.g., transmit forward data, from the first communications device 242a to the second communications device 242b, and a reverse communications link 246 configured to communicate reverse information, e.g., transmit reverse data, from the second communications device 242b to the first communications device 242a. The terms forward and reverse have no particular significance, other than they distinguish directionality according to the illustrative example.

In at least some embodiments, the bidirectional communications channel 248 may support full duplex operation. It is understood that, in at least some embodiments, the forward communications link 244 may operate in one assigned time and/or frequency assignment, while the reverse communications link 246 may operate in another assigned time and/or frequency assignment. For example, the bidirectional communications channel 248 may operate according to a frequency-division duplex (FDD) scheme in which the forward communications link 244 operates in one frequency channel or band, while the reverse communications link 246 operates in another frequency channel or band. It is understood that in at least some instances, some link degradation contributors may affect both communications links 244, 246 of the bidirectional communications channel 248, while other link degradation contributors may affect one of the forward or reverse communications links 244, 246 more than the other one. Such asymmetrical aspects of the link degradation contributors may be due, at least in part, to a location of an interferer, e.g., an unlicensed Wi-Fi interferer, being closer to one of the first and second communications devices 242a, 242b, than the other, e.g., interfering with relatively low-level received signals, while having little or no effect on higher-powered transmitted signals. In such instances, the interference may be more pronounced and/or exclusive to one of the forward or reverse communications links 244, 246. Other link degradation contributors, such may be due to atmospheric effects, e.g., atmospheric absorption and/or precipitation, lightning, may exhibit less asymmetry.

A transmitter portion of the first communications device 242a includes a first modulator and/or encoder 242a in communication with a first transmitter front end 249a. A receiver portion of the first communications device 242a includes a first receiver front end 250a in communication with a first demodulator and/or decoder 148a. The first modulator and/or encoder 247a receives forward information, encodes and/or modulates the forward information according to a forward modulation and coding scheme (MCS) and forwards the encoded and/or modulated data to the first transmitter front end 249a, which transmits a first modulated and encoded signal via the forward communications link 244 including the forward information.

Likewise, a transmitter portion of the second communications device 242b includes a second modulator and/or encoder 242b in communication with a second transmitter front end 242b. A receiver portion of the second communications device 242b includes a second receiver front end 250b in communication with a second demodulator and/or decoder 148a. The second modulator and/or encoder 247b receives reverse information, encodes and/or modulates the reverse information according to a reverse modulation and coding scheme (MCS) and provides the encoded and/or modulated data to the second transmitter front end 249b, which transmits a reverse modulated and encoded signal via the reverse communications link 246 including the reverse information.

In more detail, the first communications device 242a includes a forward adaptive coding and modulation (ACM) controller 243a in communication with the first modulator and/or encoder 247a and adapted to identify the forward MCS encoding scheme and to facilitate a reconfiguration of the first modulation and/or encoder 247a according to the forward MCS. The first communications device 242a also includes a reverse link quality monitor 244a in communication with the first demodulator and/or decoder 248a and configured to monitor, detect and/or otherwise determine a quality measure of the reverse communications link 246. Likewise, the second communications device 242b includes a reverse ACM controller 243b in communication with the second modulator and/or encoder 247b and adapted to identify the reverse MCS encoding scheme and to facilitate a reconfiguration of the second modulation and/or encoder 247b according to the reverse MCS. The second communications device 242b also includes a forward link quality monitor 244b in communication with the second demodulator and/or decoder 248b and configured to monitor, detect and/or otherwise determine a quality measure of the forward communications link 244. In at least some embodiments, the forward ACM controller 243a is in communication with the reverse link quality monitor 244a. Likewise, the reverse ACM controller 243b is in communication with the forward link quality monitor 244b.

In operation, the forward link quality monitor 244b provides the forward-link quality measure 254 to the forward ACM controller 243a of the first communications device 242a via a control channel 258. The forward ACM controller 243a receives the forward link quality measure 254 and determines a forward modulation and/or encoding scheme (MCS) responsive to the forward link quality measure 254. The forward ACM controller 243 provides a control indicator to the first modulator and/or encoder 247a that facilitates reconfiguration of the first modulator and/or encoder 247a according to the forward MCS. It is understood that in at least some embodiments, the forward ACM controller 243a is adapted to identify the forward MCS encoding scheme according to one of the forward-link quality measure 254, a reverse-link quality measure 256, or a combination of both.

Likewise, the reverse link quality monitor 244a provides the reverse-link quality measure 256 to the reverse ACM controller 243b of the second communications device 242b via the control channel 258. The reverse ACM controller 243b receives the reverse-link quality measure 256 and determines a reverse MCS responsive to the reverse link quality measure 256. The reverse ACM controller 243b provides a control indicator to the second modulator and/or encoder 247b that facilitates reconfiguration of the second modulator and/or encoder 247b according to the reverse MCS. It is understood that in at least some embodiments, the reverse ACM controller 243b is adapted to identify the reverse MCS encoding scheme according to one of the reverse-link quality measure 256, the forward-link quality measure 254, or a combination of both.

In at least some embodiments, the forward ACM controller 243a estimates a type of link degradation based on one of the forward-link quality measure 254, a reverse-link quality measure 256, or a combination of both. For example, the ACM controller 243a may monitor, measure and/or otherwise determine an estimate of symmetry or asymmetry between forward and reverse link quality measures 254, 256. The ACM controller 243a may apply one type of ACM algorithm for substantially symmetrical link quality measures 254, 256. For example, symmetry, may indicate that a cause of link degradation may be associated with a link quality variations that exhibit a first type or category of characteristics, such as rate of variability of link quality, including one or more of onset, dwell time and/or alleviation, durations of link quality degradation, severity of link quality degradations, and combination thereof. It is understood that the first type of characteristics may be better suited to a first ACM algorithm that adjusts one or more of the encoding and/or modulation according to a first algorithm that may adjust one or more of an MCS level, an MCS step size, a rate and/or size of MCS level adjustments, or any combination thereof.

Likewise, asymmetry may indicate that a cause of link degradation may be associated with a link quality variations that exhibit a second type or category of characteristics. It is understood that the second type of characteristics may be better suited to a second ACM algorithm that adjusts one or more of the encoding and/or modulation according to a second algorithm that may adjust one or more of an MCS level, an MCS step size, a rate and/or size of MCS level adjustments, or any combination thereof. For example, asymmetry in link quality measures may be indicative of localized interference as may be encountered from equipment operating according to unlicensed Wi-Fi. In at least some embodiments, asymmetry may be determined according to a comparison between EVM values obtained via the forward and reverse link quality measures 254, 256. It is envisioned that a threshold value may be applied as may be predetermined, e.g., according to historical observations, site surveys, application of link estimates and/or modelling, and so on. Accordingly, the ACM controller may apply an algorithm well suited for such bursty interference.

An example of an algorithm well suited or bursty interference may apply an initial reduction of a substantial level of modulation and/or encoding. For example, a first modulation that maps a first number of bits, N, to each symbol may be reduced to a second modulation that maps a second, lesser number of bits, M, to each symbol in response to detecting bursty interference. The difference between N and M, i.e., N-M may be more than 1 bit, more than 2 bits, or more than an even greater number. For example, a first modulation of 64 QAM, i.e., 6-bits per symbol, may be reduced to a substantially lesser modulation, such as 16 QAM, QPSK or even BPSK, i.e., 4, 2 or 1 bits per symbol. Alternatively, or in addition, an FEC level, or rate may be adjusted, e.g., to effectively add more redundant bits in view of the interference. In at least some embodiments, different levels of MCS are ordered, e.g., according to an MCS index. Combinations of modulations and codes may be varied independently and/or in combination according to the different index levels. For example, a higher index value and/or higher level of MCS may correspond to a greater capacity for information exchange, e.g., information data rate, whereas a lower index value and/or lower level of MCS may correspond to a lesser capacity for information exchange.

It is further understood that an ACM algorithm may identify a number of MCS levels and/or index values lowered in an initial adjustment. In at least some embodiments, the ACM algorithm may identify a number of MCS levels and/or number of MCS level step adjustments that may be applied to return operation of a communications link to a maximum and/or optimum MCS level in view of information exchange.

FIG. 2D is a graph 260 illustrating an example, non-limiting embodiment of performance of an ACM process functioning within the communications networks of FIGS. 1 and 2A through 2C, in accordance with various aspects described herein. The example graph displays an MCS-level-versus-time curve 262. The vertical axis corresponds to MCS level. The MCS level may correspond to a level of modulation, a level of encoding, and/or a combined level of modulation and coding. Generally, a higher level corresponds to a modulation and or coding that is well suited for meeting a business objective. For example, the MCS level may correspond to a combination of modulation and forward error correction (FEC) encoding that supports a target level of information transfer, e.g., according to a bit rate, a frame rate, and the like. The target level of information may be determined according to an estimated capacity of a communications channel, fulfillment of a user or customer requirement, satisfaction of a service requirement, and so on.

According to the illustrative example, at time T₀, the MCS-level-versus-time curve 262 is at an MCS_{HI} level, corresponding to a first MCS level, e.g., a preferred and/or optimal MCS level for a corresponding communications link. At some later time, Tx, a reduction in quality is detected and/or otherwise reported. For example, an EVM reported by a receiver may signify an error value significant enough to require activation of an ACM algorithm. In this instance, the ACM algorithm response at time T₁ by reducing the MCS level from the MCS_{HI} level, to a substantially lower MCS level, referred to herein as MCS_{LO}. The relatively large and sudden reduction in MCS level is identified as ΔMCS_{BIG}. According to the ACM algorithm, the MCS level may be increased incrementally. For example, at a first later time T₂>T₁, occurring after a first time interval, ΔT₁, the MCS level may be incrementally increased by a first relatively small increase represented as ΔMCS_{SMALL_1}.

According to the ACM algorithm, the MCS level may be continually increased incrementally until it returns to the initial MCS_{HI} level. For example, at a second later time T₃>T₂, occurring after a second time interval, ΔT₂, the MCS level may be incrementally increased by a second relatively small increase represented as ΔMCS_{SMALL_2}. Likewise, at a third later time T₄>T₃, occurring after a third time interval, ΔT₃, the MCS level may be incrementally increased by a third relatively small increase represented as ΔMCS_{SMALL_3}, and again, at a fourth later time T₅>T₄, occurring after a fourth time interval, ΔT₄, the MCS level may be incrementally increased by a fourth relatively small increase represented as ΔMCS_{SMALL_4}. According to the illustrative example, the MCS level has returned to MCS_{HI} after the fourth relatively small increase.

It is understood that one or more of the MCS level step size, MCS level step number and/or dwell time at any particular MCS level may be determined according to an ACM algorithm. Dwell times may be determined in part according to a minimum dwell time that alone or in combination with MCS step size and/or number may determine a minimum time for return-to-normal operations. For example, a single interfering burst may interfere with a portion of a single frame, e.g., symbols of one or more subframes of the single frame. Upon detection of such an event via EVM measurements, the ACM module may impose an MCS adjustment reducing an MCS by a predetermined number of levels. Presuming the interference is not enduring, the MCS adjustments may be applied, e.g., according to the illustrative example, to return to an initial MCS level.

FIG. 2E depicts an illustrative embodiment of an ACM process 270 in accordance with various aspects described herein. According to the example ACM process 270, a quality of a communications link operating at a first MCS level is monitored, at 271. The first MCS level may represent an optimal MCS level according to an applicable business objective, such as maximization of data throughput according to a predetermined quality. According to the example ACM process 270, a determination is made at 272 regarding an acceptability of a link quality. To the extent it is determined at 272 that the link quality is acceptable, the ACM process 270 returns to monitoring, at 271, the quality of the communications link operating at the first MCS level. However, to the extent it is determined at 272 that the link quality is not acceptable, the ACM process 270 proceeds to adjust, at 273, a level of MCS to a substantially lower level.

Continuing with the example ACM process 270, a quality of a communications link operating at the reduced MCS level is monitored, at 274. A determination is made at 275 as to whether a quality of the communications link has improved. To the extent it is determined at 275 that the quality has not improved, the example ACM process 270 continues to monitor at 274 for improvements. To the extent a determination is made at 275 that the link quality has improved, the ACM process 270 may increase, at 276, a level of the MCS according to an incremental MCS level that is less than a difference between the first MCS level and the substantially lower MCS level. The example ACM process 270 determines, at 277, whether the incrementally adjusted MCS level has approximately reached and/or otherwise returned to the first MCS level. To the extent it has, the entire ACM process 270 may be repeated, e.g., returning to the quality monitoring at 271. However, to the extent it is determined at 277 that the MCS level has not returned to and/or otherwise reached the first MCS level, the ACM process 270 proceeds to monitor the quality of the MCS adjusted communications link at 274 and incrementally increase the MCS level at 276 responsive to improvements detected at 275, until it is determined at 277 that the incrementally increased MCS level has returned to and/or otherwise reached the first MCS level.

FIG. 2F depicts an illustrative embodiment of another ACM process 280 in accordance with various aspects described herein. According to the example ACM process 280, a quality of a communications link operating at a first MCS level is monitored, at 281. Once again, the first MCS level may represent an optimal MCS level according to an applicable business objective, such as maximization of data throughput according to a predetermined quality. According to the example ACM process 280, a determination is made at 282 regarding an acceptability of a link quality. To the extent it is determined at 282 that the link quality is acceptable, the ACM process 280 returns to monitoring, at 281, the quality of the communications link operating at the first MCS level. However, to the extent it is determined at 282 that the link quality is not acceptable, the ACM process 280 proceeds to determine, at 283, a likelihood of bursty interference. To the extent it is determined at 283 that bursty interference is unlikely, the ACM process 280 applies, at 284b, a non-bursty ACM algorithm. Alternatively, to the extent it is determined at 283 that bursty interference is likely, the ACM process 280 applies, at 284a, a bursty ACM algorithm. The MCS level is reduced, at 285, from the first MCS level to a lower MCS level according to the ACM algorithm applied at 284a, 284b.

Continuing with the example ACM process 280, a quality of a communications link operating at the reduced MCS level is monitored, at 286. A determination is made at 287 as to whether a quality of the communications link has improved. To the extent it is determined at 286 that the quality has not improved, the example ACM process 280 continues to monitor at 286 for improvements. To the extent a determination is made at 287 that the link quality has improved, the ACM process 280 may increase, at 288, a level of the MCS according to the MCS algorithm applied at 284a, 284b. To the extent that a bursty ACM algorithm is applied at 284a, an incremental MCS level that is less than a difference between the first MCS level and the substantially lower MCS level.

The example ACM process 280 determines, at 289, whether the incrementally adjusted MCS level has approximately reached and/or otherwise returned to the first MCS level. To the extent it has, the entire ACM process 280 may be repeated, e.g., returning to the quality monitoring at 281. However, to the extent it is determined at 289 that the MCS level has not returned to and/or otherwise reached the first MCS level, the ACM process 280 proceeds to monitor the quality of the MCS adjusted communications link at 286 and incrementally increase the MCS level at 288 responsive to improvements detected at 287, until it is determined at 289 that the incrementally increased MCS level has returned to and/or otherwise reached the first MCS level.

While for purposes of simplicity of explanation, the respective processes are shown and described as a series of blocks in FIGS. 2E and 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

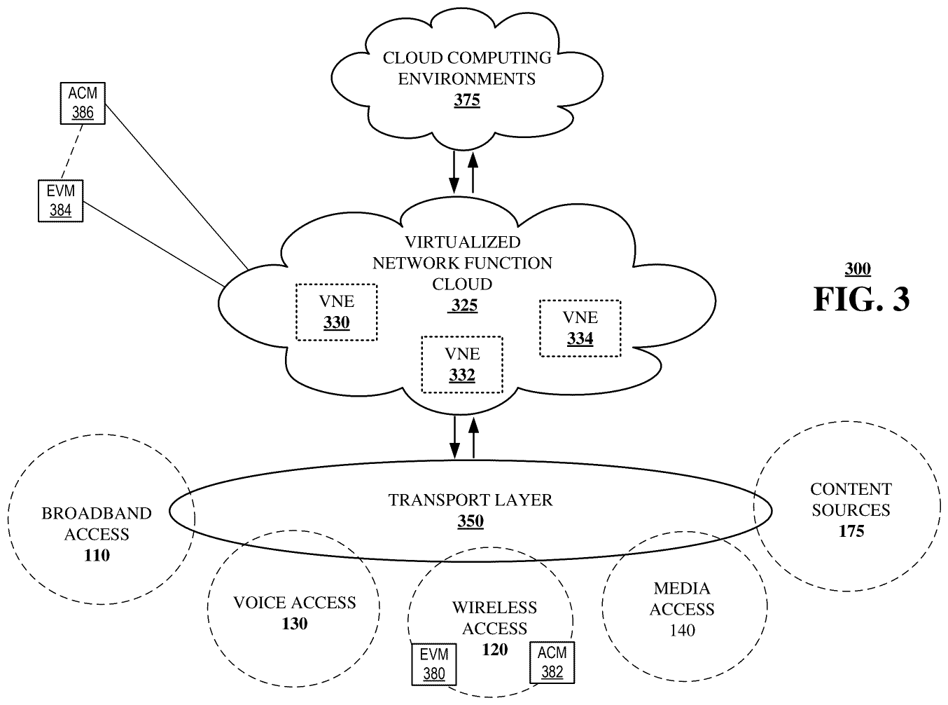

Referring now to FIG. 3, a block diagram is shown illustrating an example, non-limiting embodiment of a virtualized communications network 300 configured with adaptive coding and modulation in accordance with various aspects described herein. In particular a virtualized communications network is presented that can be used to implement some or all of the subsystems and functions of system 100, the subsystems and functions of communications systems 200, 220, 240 and processes 270 and 280 presented in FIGS. 1, 2A, 2B, 2C, 2E, 2F and 3. For example, virtualized communications network 300 can facilitate in whole or in part, measuring a quality of a communications link according to a received signal, characterizing interference according to the measured quality, and selecting an ACM algorithm from among a group of different ACM algorithms based on the characterized interference. The selected ACM algorithm is adapted to increase information throughput of the communications link over alternative ACM algorithms of the group of different ACM algorithms in view of the characterized interference.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communications services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

In at least some embodiments, the virtualized communications network 300 includes a link quality assessment module 380 configured to assess a quality of a communications link. By way of example, quality may be assessed according to EVM values that may be combined, e.g., according to a mean-squared-error (MSE) process, to obtain MSE values indicative of a link quality. Alternatively, or in addition, the communications network 100 may include an ACM controller 382, adapted to implement an ACM algorithm to control one of a modulation complexity and/or error correction rate in response to the MSE values. The ACM controller 382 may be configured to adjust the modulation and/or coding according to an algorithm adapted to return operation to pre-adjustment, e.g., maximum or optimal MCS values. Without limitation, the link quality assessment module 380 and/or the ACM controller 382 may be provided as real and/or virtual functions within the wireless access 120 portion of the virtualized communications network 300. Alternatively, or in addition, one or more of a link quality assessment module 384 and an ACM controller 386 may be provided separate from communications equipment, e.g., virtualized according to the cloud computing environment 375 and/or the virtualized network function cloud 325.

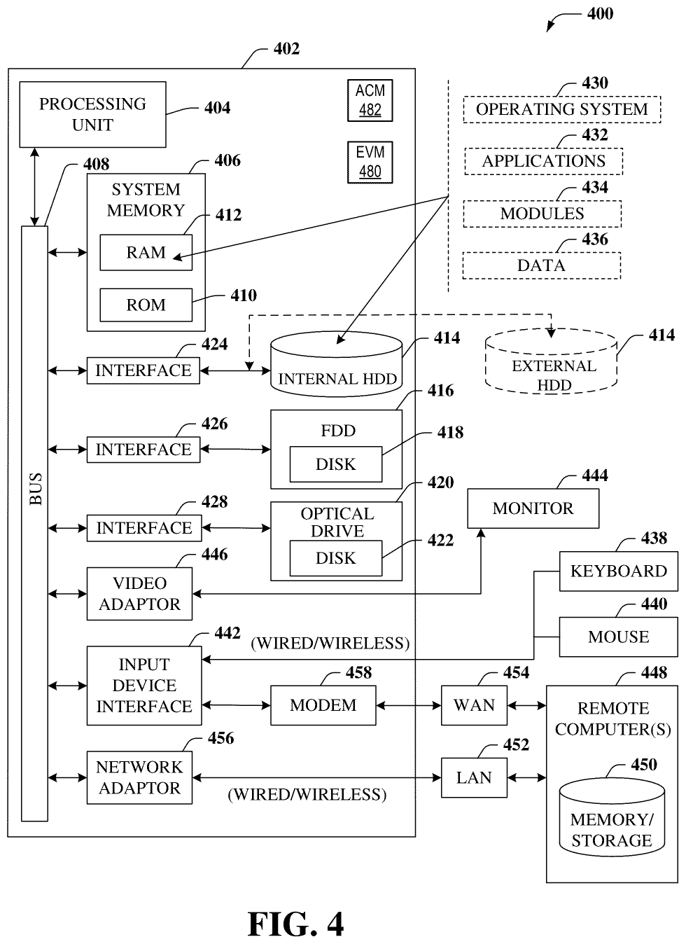

Turning now to FIG. 4, there is illustrated a block diagram of a computing environment 400 configured with adaptive coding and modulation in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part, measuring a quality of a communications link according to a received signal, characterizing interference according to the measured quality, and selecting an ACM algorithm from among a group of different ACM algorithms based on the characterized interference. The selected ACM algorithm is adapted to increase information throughput of the communications link over alternative ACM algorithms of the group of different ACM algorithms in view of the characterized interference.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communications media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communications means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communications to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communications can be a predefined structure as with a conventional network or simply an ad hoc communications between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4, 5 and 6 GHz radio bands for example or with products that contain both bands (dual band), so the networks can provide real-world performance similar to the basic wired Ethernet networks used in many offices.

In at least some embodiments, the computing environment 400 includes a link quality assessment module 480 configured to assess a quality of a communications link. By way of example, quality may be assessed according to EVM values that may be combined, e.g., according to a mean-squared-error (MSE) process, to obtain MSE values indicative of a link quality. Alternatively, or in addition, the computing environment 400 may include an ACM controller 482, adapted to implement an ACM algorithm to control one of a modulation complexity and/or error correction rate in response to the MSE values. The ACM controller 482 may be configured to adjust the modulation and/or coding according to an algorithm adapted to return operation to pre-adjustment, e.g., maximum or optimal MCS values.

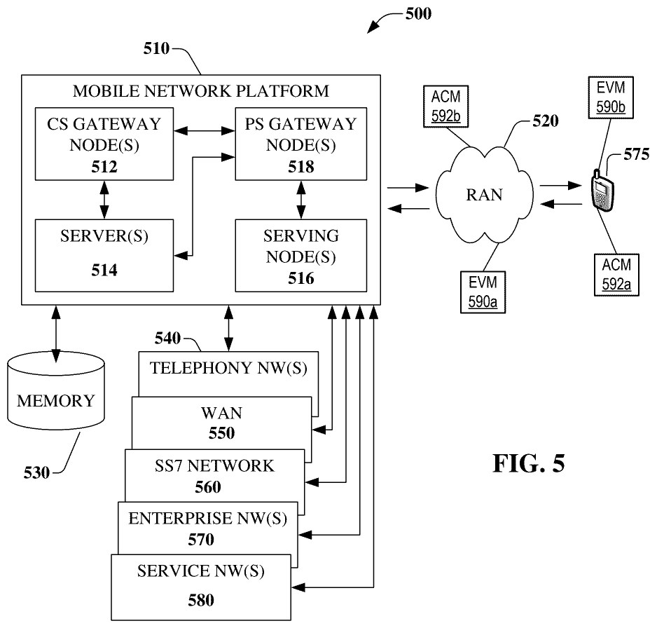

Turning now to FIG. 5, an embodiment 500 of a mobile network platform 510 configured with adaptive coding and modulation is shown that is an example of network elements 150, 152, 154, 156, and/or VNEs 330, 332, 334, etc. For example, platform 510 can facilitate in whole or in part, measuring a quality of a communications link according to a received signal, characterizing interference according to the measured quality, and selecting an ACM algorithm from among a group of different ACM algorithms based on the characterized interference. The selected ACM algorithm is adapted to increase information throughput of the communications link over alternative ACM algorithms of the group of different ACM algorithms in view of the characterized interference. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunications over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center.

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communications thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communications served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunications protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

In at least some embodiments, the embodiment 500 of the mobile network platform 510 includes a link quality assessment module 590b, e.g., at the radiotelephone 575, configured to assess a quality of a communications link. By way of example, quality may be assessed according to EVM values that may be combined, e.g., according to a mean-squared-error (MSE) process, to obtain MSE values indicative of a link quality. Alternatively, or in addition, the embodiment 500 of the mobile network platform 510 may include an ACM controller 592a, adapted to implement an ACM algorithm to control one of a modulation complexity and/or error correction rate in response to the MSE values. The ACM controller 592a may be configured to adjust the modulation and/or coding according to an algorithm adapted to return operation to pre-adjustment, e.g., maximum or optimal MCS values. Without limitation, the link quality assessment module 590b and/or the ACM controller 592a may be included within one or more of the radiotelephones 575. Alternatively, or in addition, one or more of a link quality assessment module 590a and an ACM controller 592b may be provided separate from communications equipment, e.g., within the radio access network 520.

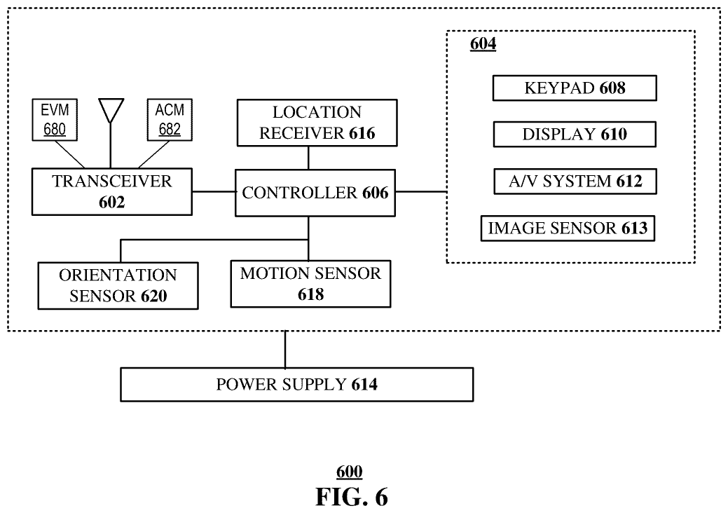

Turning now to FIG. 6, an illustrative embodiment of a communications device 600 is shown. The communications device 600 is configured with adaptive coding and modulation and can serve as an illustrative embodiment of devices such as data terminals 114, mobile devices 124, vehicle 126, display devices 144 or other client devices for communications via either communications network 125. For example, computing device 600 can facilitate in whole or in part measuring a quality of a communications link according to a received signal, characterizing interference according to the measured quality, and selecting an ACM algorithm from among a group of different ACM algorithms based on the characterized interference. The selected ACM algorithm is adapted to increase information throughput of the communications link over alternative ACM algorithms of the group of different ACM algorithms in view of the characterized interference.

The communications device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communications technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communications technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communications device 600. The keypad 608 can be an integral part of a housing assembly of the communications device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communications device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communications device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communications device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communications device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communications device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communications device 600 in three-dimensional space. The orientation sensor 620 can utilize orientation sensing technology such as a magnetometer to detect the orientation of the communications device 600 (north, south, west, and east, as well as combined orientations in degrees, minutes, or other suitable orientation metrics).

The communications device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communications device 600.

Other components not shown in FIG. 6 can be used in one or more embodiments of the subject disclosure. For instance, the communications device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

In at least some embodiments, the communications device 600 includes a link quality assessment module 680, configured to assess a quality of a communications link. By way of example, quality may be assessed according to EVM values that may be combined, e.g., according to a mean-squared-error (MSE) process, to obtain MSE values indicative of a link quality. Alternatively, or in addition, the communications device 600 may include an ACM controller 682, adapted to implement an ACM algorithm to control one of a modulation complexity and/or error correction rate in response to the MSE values. The ACM controller 682 may be configured to adjust the modulation and/or coding according to an algorithm adapted to return operation to pre-adjustment, e.g., maximum or optimal MCS values.

Although the examples disclosed herein are directed to wireless communications links including LoS systems, it is understood that the techniques disclosed herein, including systems, processes and software, may be applied more generally to any communications system. Examples include, without limitation, wireless communications systems, such as radio communications systems, including microwave and/or millimeter wave communications systems, infrared communications systems, free-space optical communications systems, satellite communications systems, and the like. Although the novel techniques disclosed herein, including ACM are particularly well suited for wireless communications applications, it is understood that they may be applied alternatively or in addition to other communications systems, such as tethered communications systems. Examples include, without limitation, tethered communications systems including one or more of electrical waveguides, coaxial cables, twisted copper pair, dielectric waveguides, optical fibers, and the like.

Although the examples disclosed herein are directed adaptive coding and modulation, it is understood that the techniques disclosed herein, including systems, processes and software, may be applied more generally to adaptive modulation, adaptive coding and/or combinations of adaptive modulation and coding. Modulation may include any form of modulation adapted to convey information over a communications link. Example modulations include, without limitation, amplitude modulation, e.g., ASK, frequency modulation, e.g., FSK, phase modulation, e.g., PSK, and any combination thereof. Other example modulations include, without limitation, on-off keying (OOK), binary-phase-shift keying (BPSK), quadrature-phase-shift keying (QPSK), quadrature-amplitude modulation (QAM), trellis coding, and the like.

It is understood that sources of signal degradation affecting a quality of a communications system, communications link and/or communications channel, as may be compensate for with any of the techniques disclosed herein, include, without limitation, interference from man-made sources, interference from naturally occurring sources, and interference from any combination thereof. Naturally occurring sources may include one or more of atmospheric events, such as precipitation, lightening, multipath, physical obstruction and so on. Interference from man-made sources may include, without limitation, interference from another communications system, other non-communications systems, such as machinery and/or processes, e.g., welding, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communications service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communications paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a processing system including a processor, a signal comprising information transmitted over a physical channel of a communications link, to obtain a received signal;
calculating, by the processing system, a quality measure of the communications link according to the received signal;
characterizing, by the processing system, interference according to the quality measure of the communications link, to obtain characterized interference; and
selecting, by the processing system, an adaptive coding and modulation (ACM) algorithm from among a plurality of different ACM algorithms based on the characterized interference, to obtain a selected ACM algorithm, wherein the selected ACM algorithm is adapted to increase information throughput of the communications link over alternative ACM algorithms of the plurality of different ACM algorithms in view of the characterized interference.

2. The method of claim 1, wherein the communications link comprises a digital communications link, and wherein the received signal comprises a plurality of received symbols grouped into a plurality of transport frames.

3. The method of claim 2, wherein the calculating the quality measure of the communications link further comprises:
calculating, by the processing system, a plurality of error vector magnitudes of the plurality of received symbols.

4. The method of claim 3, wherein the calculating the plurality of error vector magnitudes further comprises:
calculating, by the processing system, a root-mean-square (RMS) value of the plurality of error vector magnitudes, wherein the quality measure of the communications link comprises the RMS value of the plurality of error vector magnitudes.

5. The method of claim 4, wherein the calculating the quality measure of the communications link further comprises:
calculating, by the processing system, a first RMS value of a first group of the plurality of error vector magnitudes associated with a first subgroup of symbols of the plurality of received symbols of a transport frame of the plurality of transport frames;
calculating, by the processing system, a second RMS value of a second group of the plurality of error vector magnitudes associated with a second subgroup of symbols of the plurality of received symbols of the transport frame of the plurality of transport frames; and
comparing, by the processing system, the first RMS value to the second RMS value to obtain a comparison, wherein the selecting the ACM algorithm from among a plurality of different ACM algorithms is based on the comparison.

6. The method of claim 1, wherein the characterizing the interference according to the quality measure of the communications link further comprises:
determining, by the processing system, a severity of the interference; and
determining, by the processing system, a rate of onset of the interference, wherein the selecting the ACM algorithm from among the plurality of different ACM algorithms is based on the severity of the interference and the rate of onset of the interference.

7. The method of claim 6, wherein the characterizing the interference further comprises:
identifying, by the processing system, an interference source operating in an unlicensed wireless spectrum according to a combination of the severity of the interference and the rate of onset of the interference.

8. The method of claim 1, wherein the ACM algorithm comprises adjusting a modulation and coding scheme (MCS) applied to the signal, the MCS establishing one of a modulation complexity, an error encoding rate, or a combination of thereof.

9. The method of claim 8, wherein the MCS comprises a plurality of predetermined MCS levels corresponding to varying degrees of modulation complexities, error encoding rates, or combinations thereof, and wherein higher MCS levels of the plurality of predetermined MCS levels correspond to greater information throughput of the communications link than lower MCS levels of the plurality of predetermined MCS levels.

10. The method of claim 1, wherein the characterizing the interference further comprises:
identifying, by the processing system, bursty interference characterized by sudden and intense interference, and wherein the selecting of the ACM algorithm further comprises:
selecting, by the processing system, the ACM algorithm to obtain a bursty ACM algorithm according to the bursty interference, wherein the bursty ACM algorithm triggers an immediate multi-level reduction in a modulation and coding scheme (MCS) complexity, wherein the MCS complexity comprise a complexity of a modulation, a complexity of an error coding, or complexities of both the modulation and the error coding.

11. The method of claim 10, further comprising:
increasing, by the processing system and subsequent to the immediate multi-level reduction in MCS complexity, the MCS complexity according to a multi-step process, wherein each step of the multi-step process increases the MCS complexity by an incremental level of a plurality of incremental MCS complexity levels, each incremental MCS complexity of the plurality of incremental MCS complexity levels less than the immediate multi-level reduction in MCS complexity.

12. The method of claim 1, wherein the communications link comprises a frequency division duplex (FDD) communications link comprising a forward link portion and a reverse link portion, the calculating the quality measure of the communications link further comprising:
determining, by the processing system, a forward quality measure of the forward link portion;
determining by the processing system, a reverse quality measure of the reverse link portion; and
determining, by the processing system, a difference between forward quality measure to the reverse quality measure to obtain a directional quality difference.

13. The method of claim 12, further comprising:
comparing, by the processing system, the directional quality difference to a threshold, wherein the selecting the ACM algorithm is based on the directional quality difference.

14. A system, comprising:
a processing system including a processor; and
a memory that stores executable instructions that, when executed by the processing system, facilitate performance of operations, the operations comprising:
obtaining a received signal comprising information transmitted over a physical channel of a communications link;
measuring a quality of the communications link according to the received signal, to obtain a measured quality;
characterizing interference according to the measured quality, to obtain characterized interference; and
selecting an adaptive coding and modulation (ACM) algorithm from among a plurality of different ACM algorithms based on the characterized interference, to obtain a selected ACM algorithm, wherein the selected ACM algorithm is adapted to increase information throughput of the communications link over alternative ACM algorithms of the plurality of different ACM algorithms in view of the characterized interference.

15. The system of claim 14, wherein the characterizing the interference according to the measured quality of the communications link further comprises:
determining a severity of the interference; and
determining a rate of onset of the interference, wherein the selecting the ACM algorithm from among the plurality of different ACM algorithms is based on the severity of the interference and the rate of onset of the interference.

16. The system of claim 15, wherein the characterizing the interference further comprises:
identifying an interference source operating in an unlicensed wireless spectrum according to a combination of the severity of the interference and the rate of onset of the interference.

17. The system of claim 15, wherein the ACM algorithm comprises adjusting a modulation and coding scheme (MCS) applied to a transmission of the received signal, the MCS establishing one of a modulation complexity, an error encoding rate, or a combination of thereof, and wherein the MCS comprises a plurality of predetermined MCS levels corresponding to varying degrees of modulation complexities, error encoding rates, or combinations thereof, and wherein higher MCS levels of the plurality of predetermined MCS levels correspond to greater information throughput of the communications link than lower MCS levels of the plurality of predetermined MCS levels.

18. A non-transitory, machine-readable medium, comprising executable instructions that, when executed by a processing system including a processor, facilitate performance of operations, the operations comprising:
obtaining a received signal comprising information transmitted over a physical channel of a communications link;
determining a quality metric of the communications link according to the received signal;
identifying, according to the quality metric, a type of interference from among a plurality of different types of interference, to obtain an identified type of interference; and
configuring an adaptive coding and modulation (ACM) algorithm according to the identified type of interference, to obtain a configured ACM algorithm, wherein the configured ACM algorithm is adapted to optimize information throughput of the communications link.

19. The non-transitory, machine-readable medium of claim 18, wherein the identifying the type of interference link further comprises:
determining a severity of the interference; and
determining a rate of onset of the interference, wherein the configuring the ACM algorithm is based on the severity of the interference and the rate of onset of the interference.

20. The non-transitory, machine-readable medium of claim 19, wherein the identifying the type of interference further comprises:
identifying an interference source operating in an unlicensed wireless spectrum according to a combination of the severity of the interference and the rate of onset of the interference.
